(19) United States
(12) Patent Application Publication
(10) Pub. No.: US 2007/0055472 A1
(43) Pub. Date: Mar. 8, 2007

(54) Method and system for transfer of data in a wireless network

(75) Inventor: James O'Toole, Somerville, MA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/209,554

(22) Filed: Aug. 23, 2005

(51) Int. Cl. G01D 1/00

(52) U.S. Cl. 702/127

(57) ABSTRACT

The various embodiments of the invention provide a method, system, apparatus and machine-readable medium for transfer of data in a wireless network. The method involves identification of nodes through which the data can be transferred. The method further involves monitoring of parameters associated with a battery in the node. In addition, the methodit involves selection of a node among the identified nodes. Further, the method further involves transfer of the data through the selected node.

### BACKGROUND OF THE INVENTION

1. Field of Invention

Embodiments of the invention relate in general to transfer of data in a network. More specifically, the embodiments of the invention relate to methods and systems for transferring data in a wireless network.

2. Description of the Background Art

Over the past few years, networking has become a necessity in commercial, industrial, consumer, military and medical fields. Wireless sensor ad-hoc networks are increasingly being deployed in factory environments that are characterized by low-power requirements and low bandwidth. Sensor networking in factories assists in monitoring and maintaining process parameters such as temperature, pressure, etc. Wireless ad-hoc networking enhances the flexibility of the installation of the nodes in the wireless network, which are supplied with a battery source.

In order to maintain the process parameters of the factory, the node needs to share data with other nodes in the network. This requires transfer of data from one node to another. The node from which the data is transferred is known as a ‘source node’, and the node to which the data is transferred is known as a ‘destination node’. Data may directly or indirectly be transferred to the destination node. Indirect transfer of data to the destination node is accomplished through one or more intermediate nodes. The intermediate nodes are also referred to as ‘relay nodes’. The selection of a relay node is made by a routing algorithm. The routing algorithms make selections based on bandwidth, hop count, communication cost, path cost, load, maximum transmission unit (MTU), reliability, etc.

The battery energy of the node is expended when data is transferred through it. Repeated use of a node to transfer data may completely exhaust the battery of the node. The depleted energy of the battery needs to be regenerated, but this adds to the cost of maintaining power in the network. Further, rapid depletions of the battery disrupt connectivity and result in collapse of the network. Therefore, the battery power of the node is a critical factor in reducing the cost of maintaining power in the network. To avoid rapid depletion of the batteries in the nodes, data should be transferred in a manner that conserves power in the network.

Conventional approaches to transfer of data for conserving power include implementation of a routing algorithm that selects relay nodes on the basis of longest-expected-battery-lifetime. Another approach is the implementation of a greedy algorithm that selects relay nodes, which ensure the lowest energy expense in the transfer process. Further, the existing routing algorithms can prevent an excessive burden being placed on the battery of the node by suggesting various options. These options include increasing the battery size of the node, adding more mesh nodes in the network, and converting the node to a wire line-powered node.

Examples of the conventional approaches include a power-aware routing algorithm. The power-aware routing algorithm aims to prolong the life of the entire network by finding routing paths that maximize the lifetime of individual nodes. Moreover, the power-aware routing algorithm minimizes the total transmission energy consumption for transfer of data.

However, these approaches do not monitor the expected time of regeneration of the batteries, and expected cost of regeneration of the batteries for selection of a relay node. Regeneration of the battery may involve a replacement of the battery with a fresh and fully charged battery, and/or it may involve a recharging of the battery. Further, the power-aware routing algorithms do not take into consideration various economic factors affecting the power maintenance of the network.

### BRIEF DESCRIPTION OF THE DRAWINGS

FIG. 1 illustrates an environment wherein an exemplary embodiment of the invention can be practiced.

FIG. 2 is a flowchart of a method for transfer of data in a wireless network, in accordance with an exemplary embodiment of the present invention.

FIG. 3 is a block diagram of a data transfer system, in accordance with an exemplary embodiment of the present invention.

### DETAILED DESCRIPTION OF EMBODIMENTS OF THE INVENTION

Various embodiments of the invention provide a method, system, apparatus and machine-readable medium for transfer of data in a wireless network. The method involves identification of nodes through which the data can be transferred. The method further involves selection of a node from amongst the identified nodes. The selection is based on parameters associated with a battery of the node. The method further involves transfer of the data through the selected node.

The system includes a node identifier to identify nodes through which the data can be transferred. The system further includes a parameter assessment module to monitor parameters associated with the battery of the node. In addition, the system includes a node selector to select a node from amongst the identified nodes. Further, the system includes a data transfer module to transfer data to the selected node.

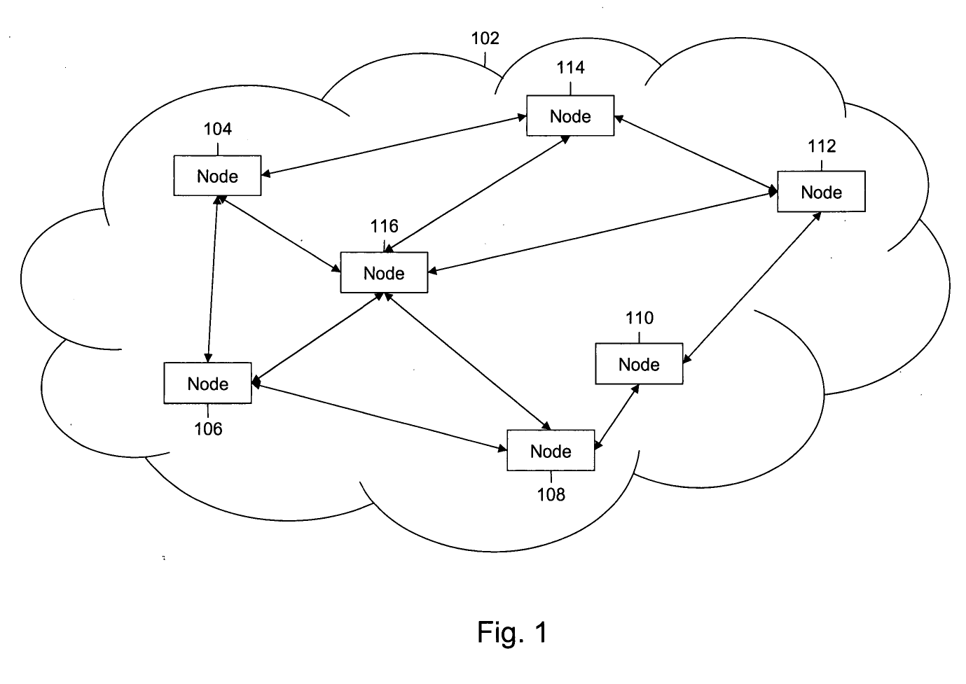

FIG. 1 illustrates an environment wherein an exemplary embodiment of the invention can be practiced. The environment includes a network 102. Network 102 can be a Local Area Network (LAN), a Wide-Area Network (WAN), ad-hoc networks, and the like. For example, network 102 is a wireless LAN deployed in a power plant to monitor and maintain the working conditions of the plant.

Network 102 includes multiple nodes 104, 106, 108, 110, 112, 114 and 116. The nodes are supplied with battery power. The nodes are linked with one another, to transfer data within network 102. For example, node 106 is linked with node 108, and node 108 is linked with node 110. Node 106 transfers data to node 110 through node 108. The nodes may be organized in a full-mesh topology, partial mesh topology, and the like. In a full-mesh topology, every node is connected to every other node in a network. In a partial mesh topology, nodes may not be connected to all other nodes in the network. Examples of nodes include factory measurement devices, remote control switches, vibration sensors, water-level sensors, pressure gages, thermostats, and utility meters.

For example, nodes 104, 106, 108, 110, 112, 114 and 116 are Temperature Control Devices (TCDs) arranged in a partial mesh topology in a power plant. Each TCD needs to share temperature values with other TCDs in the power plant, in order to maintain the temperature conditions of the plant. Sharing of temperature values require transfer of temperature values from one TCD to another in the network.

For example, referring to FIG. 1, node 104 needs to transfer a temperature value to node 110. There may be more than one route through which the temperature value may be transferred from node 104 to node 110. The route may be a single-hop route or a multi-hop route. A single-hop route is used when the temperature value is directly transferred from node 104 to node 110. A multi-hop route is used when the temperature value is transferred from node 104 to node 110 through at least one intermediate node. For example, the multi-hop route used by node 104 to transfer a temperature value to node 110 is node 104→node 106→node 108→node 110.

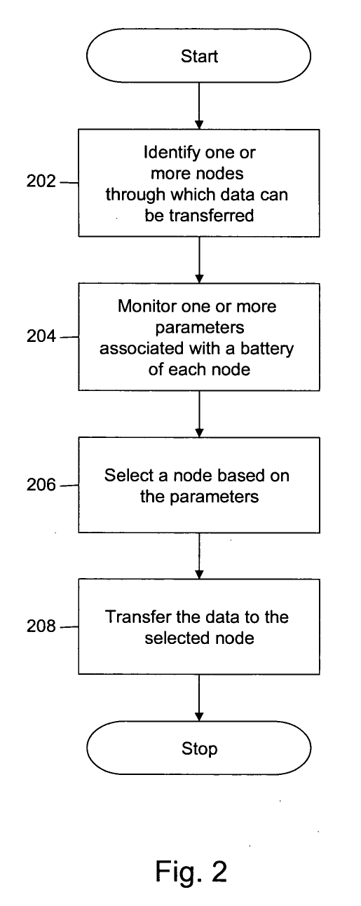

FIG. 2 illustrates a flowchart of a method for the transfer of data from one node to another node in the network, in accordance with an exemplary embodiment of the invention. At step 202, nodes through which a data can be transferred are identified. For example, with reference to FIG. 1, if the data is transferred from node 104 to node 110, in network 102, the nodes identified are 106, 108, 112, 114, and 116.

At step 204, at least one of the parameters associated with a battery of each node are monitored. Thereafter, at step 206, a node is selected on the basis of the parameters monitored at step 204. Subsequently, at step 208, the data is transferred to the node selected at step 206.

Referring to step 204, the parameters associated with the battery include the cost of regeneration of the battery, the time of regeneration of the battery, and the energy expense incurred for the transfer of data. Regeneration of the battery may involve a replacement of the battery with a fresh and fully charged battery, and/or it may involve a recharging of the battery. The recharging may be performed manually or automatically. Automatic recharging may be done continuously or intermittently. The recharging may be performed by a light input such as solar light, a mechanical/vibration power extractor, and the like.

The cost of regeneration of the battery includes the cost of recharging the battery, and the cost of replacing it. The cost of the regeneration of the battery depends on several factors, including the cost of the battery and the operational cost of performing the battery recharge or the battery replacement. The operational cost of performing the battery recharge or the battery replacement depends on factors, including the location of the node. For example, if the node is easily accessible, then the operational cost is less, as compared to a node that is not easily accessible.

The time of regeneration of the battery includes the expected time to regenerate the battery, and the expected time to full-discharge of the battery. The expected time to regenerate the battery may be estimated based on the expected lifetime of the battery, current charge level of the battery, and the rate of recharging the battery. The expected time to regenerate the battery is hereinafter referred to as ‘TR’. The expected time to full-discharge of the battery may be estimated based on the current charge level of the battery, and the rate of usage of the battery. The rate of usage of the battery is the average of the usage of the battery over a recent time interval. In an embodiment of the invention, the time interval may be seven days. The expected time for full-discharge of the battery is hereinafter referred to as ‘TD’.

The overall cost of maintaining the power of the network depends on factors, including the parameters associated with the battery. For example, if the battery of node 114 has a high cost, the cost of battery recharge or battery replacement of the depleted battery of node 114 will be high. Therefore, the cost of regeneration of the battery of node 114 increases the overall cost of maintaining power in network 102. The cost of regeneration of the battery is hereinafter referred to as ‘C’. Monitoring the value of ‘C’ of node 114 serves to indicate the operator that frequent use of node 114 for the transfer of data should be avoided. Avoiding the frequent use of node 114 for the transfer of data prevents depletion of the battery of node 114. Consequently, the cost of the regeneration of the battery of node 114 is eliminated. Therefore, the overall cost of maintaining the power in network 102 is reduced.

In another example, if node 112 is located in an inaccessible location in the power plant, the operational cost of performing the battery recharge or battery replacement becomes high. Therefore, the value of C of node 112 can be high. The high value of C of node 112 increases the overall cost of maintaining the power in network 102. Monitoring the value of C of node 112 serves to indicate the operator that frequent use of node 112 for transfer of data should be avoided. Avoiding the frequent use of node 112 for transfer of data prevents depletion of the battery in node 112. Consequently, the cost of regeneration of the battery in node 112 is eliminated. Therefore, the overall cost of maintaining the power in network 102 is reduced.

Monitoring the values of TR and TD assists in preventing the break-down of the network. Monitoring the values of TR and TD serves to provide an adequate schedule for regeneration of the batteries in the nodes that are frequently used. Consequently, the battery of the node is regenerated before it is completely utilized. Therefore, a break-down of the network due to battery depletions is prevented.

The overall cost of maintaining power in the network further depends on the energy expense to be incurred in the transfer of data. The energy expense incurred in the transfer of data is the amount of battery energy of the node that is consumed in the transfer of data. The energy expense is estimated by the transmission power required for the transfer of data. The transmission power depends on factors, including the actual physical distance between the nodes. The energy expense to be incurred in the transfer of data is hereinafter being referred to as ‘E’. For example, if the transfer of data from node 106 to node 108 leads to a lower value of E, monitoring the value of E of node 106 serves to indicate the operator that node 106 should be used for transfer of data.

Thereafter, a node is selected, based on the monitored parameters. According to the various embodiments of the invention, the nodes identified at step 202, may include a node selected with the minimum value of C, or minimum value of TR, or maximum value of TD, or minimum value of E.

In another embodiment of the invention, a node with a minimum value of the weighted sums of C, TR, TD and E is selected. For example, a node with the minimum value of the equation is selected:
x*C+y*TR+Z*E−w*TD

where x, y, z, and w are the weighted values assigned to parameters C, TR, E and TD respectively. Thereafter, the data is transferred to the selected node.

In yet another embodiment of the invention, a plurality of routing paths through which data can be transferred from node 104 to node 110 is identified at step 202. The ways of identifying the routing paths are mentioned in a publication, ‘Weifa Liang, Yang Yuansheng; Maximizing Battery Life Routing in Wireless Ad Hoc Networks; Proceedings of the 37th Hawaii International Conference on System Sciences—2004, IEEE’. This publication is hereinafter incorporated as a reference to the present invention. A routing algorithm described by the present invention computes parameters C, E, TR, and TD for each node that constitutes each routing path identified at step 202. For example, the routing algorithm computes the value of x*C+y*TR+Z*E−w*TD for each node that constitutes each path identified at step 202. The routing algorithm then selects a path as the best routing path if the value of x*C+y*TR+Z*E−w*TD of all the nodes constituting the path is minimum.

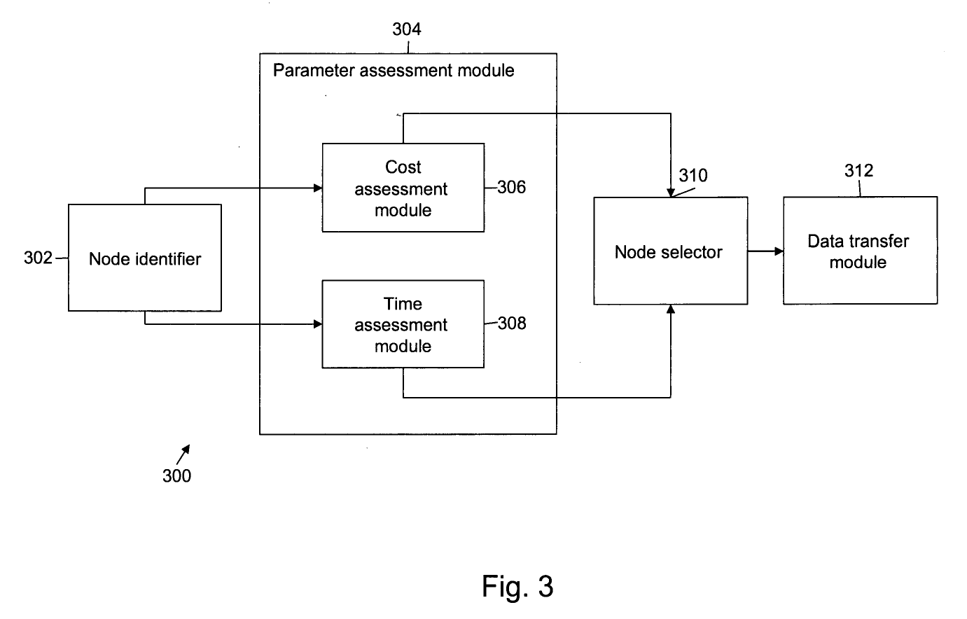

FIG. 3 is a block diagram of a data transfer system 300, in accordance with an exemplary embodiment of the invention. Data transfer system 300 includes a node identifier 302, a parameter assessment module 304, a node selector 310, and a data transfer module 312. Node identifier 302 identifies the nodes through which data can be transferred. Parameter assessment module 304 monitors the parameters associated with a battery in each node that is identified by node identifier 302.

Parameter assessment module 304 further includes a cost assessment module 306 and a time assessment module 308. Cost assessment module 306 monitors the cost of regeneration of the battery. Time assessment module 308 monitors the time of regeneration of the battery. Node selector 310 selects a node, based on the parameters monitored by parameter assessment module 304. Data transfer module 312 transfers the data to the node selected by node selector 310. The components of data transfer system 300 can be implemented in software, hardware, or a combination of both.

Various embodiments of the invention have the advantage that the method reduces the cost that may be incurred in maintaining power in the network. This is accomplished by transferring data through a node, with the minimum cost of regeneration of the battery. This is further accomplished by transferring the data through the node, which has more unexpended battery energy, as compared to the time before the next expected regeneration of the battery. Further, various embodiments of the invention involve monitoring of the time of regeneration of the battery. This provides an adequate schedule for regeneration of batteries in the nodes that are frequently used. Therefore, the anticipated break-downs in the network, due to battery depletion, are prevented. The various embodiments of the invention therefore help in maintaining the connectivity of the network.

Although the invention has been discussed with respect to specific embodiments thereof, these embodiments are merely illustrative, and not restrictive, of the invention. For example, a ‘method for transfer of data in a wireless network’ can include any type of analysis, manual or automatic, to anticipate the needs of the method.

Although specific protocols have been used to describe embodiments, other embodiments can use other transmission protocols or standards. Use of the terms ‘peer’, ‘client’, and ‘server’ can include any type of device, operation, or other process. The invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims

What is claimed is:

1. A method for transfer of data in a wireless network comprising
identifying one or more nodes through which data can be transferred;
monitoring one or more parameters associated with a battery of each node, the parameter being at least one from a group comprising cost of regeneration of the battery, and time of regeneration of the battery;
selecting a node based on the monitored parameters; and
transferring the data through the selected node.

2. The method of claim 1 wherein selecting the node comprises selecting the node with the minimum cost of regeneration of the battery.

3. The method of claim 1 wherein selecting the node comprises selecting the node with the minimum time of regeneration of the battery.

4. The method of claim 1 wherein the cost of regeneration of the battery comprises the cost of recharge of the battery.

5. The method of claim 1 wherein the cost of regeneration of the battery comprises the cost of replacement of the battery.

6. The method of claim 1 wherein the time of regeneration of the battery comprises the time of recharge of the battery.

7. The method of claim 1 wherein the time of regeneration of the battery comprises the time of replacement of the battery.

8. The method of claim 1 wherein the time of regeneration of the battery is based on the energy stored in the battery.

9. A system for transfer of data in a wireless network comprising
a node identifier for identifying one or more nodes through which data can be transferred;
a parameter assessment module for monitoring one or more parameters associated with a battery of each node, the parameter being at least one from a group comprising cost of regeneration of the battery, and time of regeneration of the battery;
a node selector for selecting a node based on the monitored parameters; and
a data transfer module for transferring the data through the selected node.

10. The system of claim 9 wherein the node selector selects the node with the minimum cost of regeneration of the battery.

11. The system of claim 9 wherein the node selector selects the node with the minimum time of regeneration of the battery.

12. The system of claim 9 wherein the cost of regeneration of the battery comprises the cost of recharge of the battery.

13. The system of claim 9 wherein the cost of regeneration of the battery comprises the cost of replacement of the battery.

14. The system of claim 9 wherein the time of regeneration of the battery comprises the time of recharge of the battery.

15. The system of claim 9 wherein the time of regeneration of the battery comprises the time of replacement of the battery.

16. The system of claim 9 wherein the time of regeneration of the battery is based on the energy stored in the battery.

17. A system for transfer of data in a wireless network comprising
means for identifying one or more nodes through which data can be transferred;
means for monitoring one or more parameters associated with a battery of each node, the parameter being at least one from a group comprising cost of regeneration of the battery, and time of regeneration of the battery;
means for selecting a node based on the monitored parameters; and
means for transferring the data through the selected node.

18. An apparatus for transfer of data in a wireless network, the apparatus comprising
a processor; and
a machine-readable medium including instructions executable by the processor comprising
one or more instructions for identifying one or more nodes through which data can be transferred;
one or more instructions for monitoring one or more parameters associated with a battery of each node, the parameter being at least one from a group comprising cost of regeneration of the battery, and time of regeneration of the battery;
one or more instructions for selecting a node based on the monitored parameters; and
one or more instructions for transferring the data through the selected node.

19. A machine-readable medium including instructions executable by a processor for transfer of data in a wireless network, comprising
one or more instructions for identifying one or more nodes through which data can be transferred;
one or more instructions for monitoring one or more parameters associated with a battery of each node, the parameter being at least one from a group comprising cost of regeneration of the battery, and time of regeneration of the battery;
one or more instructions for selecting a node based on the monitored parameters; and
one or more instructions for transferring the data through the selected node.
